(19) United States
(12) Patent Application Publication
(10) Pub. No.: US 2012/0285769 A1
(43) Pub. Date: Nov. 15, 2012

(54) SCAFFOLDING ARRANGEMENT AND METHOD OF ASSEMBLY

(76) Inventors: Neil ROONEY, Wollongong (AU); Dane CARTLEDGE, Mangerton (AU); Mark PAYER, Windang (AU)

(21) Appl. No.: 13/447,420

(22) Filed: Apr. 16, 2012

Related U.S. Application Data
(63) Continuation-in-part of application No. 12/250,841, filed on Oct. 14, 2008, now abandoned.

(30) Foreign Application Priority Data
Oct. 17, 2007 (AU) 2007905667

(51) Int. Cl. E04G 1/02; B23P 11/00; A62B 35/00

(52) U.S. Cl. 182/3; 182/179.1; 182/130; 29/428

(57) ABSTRACT

A scaffolding assembly including at least one scaffolding climbing tower defined by four corner standards, two or more working platforms, and one or more intermediate platforms between at least one pair of working platforms.

### FIELD OF THE INVENTION

This invention relates to a scaffolding assembly and method of assembling scaffolding.

In particular, the invention relates to the construction of a scaffolding climbing tower and to its use.

### BACKGROUND OF THE INVENTION

The assembling of scaffolding is subject to the risk of injury to the workers assembling the scaffolding and there are also risks of injury for the workers using the scaffolding. The risks in assembling the scaffolding include risk of falls and risk of lifting injury.

In some countries, scaffold builders are required to wear a harness and lanyard attached to the scaffolding, usually a ledger by a suitable connector. Additional safety regulations may require, for example, that the lanyard be attached above the shoulder of the worker to limit the distance of a potential fall. However, in practice, this may not always be practicable, because the worker may be in a position in which there is no ledger at or above shoulder height. In addition, 2 m lanyards include an elastic segment to slow a fall. However, this requires a fall distance of about 6 m before the fall is arrested.

FIG. 1 illustrates the current method of erecting scaffolding in which only the working platforms are installed. Each column of bays is erected starting from the bottom and working vertically. This requires the worker 1.84 standing on platform 1.11 to lift the boards 1.01 to the next working platform 1.12 to install them. The next level is typically 2 m above the level on which the worker is standing. The worker will usually install only one or two boards per level and then climb up the standard 1.06 or 1.08 using cups 1.30 as foot holds, and continue in this manner adding the ledgers, transoms and standards as required until all levels have been installed with one or two one or boards. Each level is used as the platform for the worker to erect the next level. Using this method, there are periods when the worker does not have an anchor point above shoulder height. In some instances, the lanyard is attached at the level of the worker's foot. Further, with one or two boards, there is a direct fall line through the vertical line of bays. In addition, the boards can slide along the transoms.

FIG. 2 schematically illustrates a working bay having three full platforms.

The standards have a length of 3.2 m with a male/female connexion for additional standards. The addition of standards requires the end-to-end alignment of the standards, and the worker can be required to add additional standards at a height of 2 m above the platform on which the worker is standing. This can be very difficult due to the weight and length of the standard and the height at which it must be installed.

The lanyards used in the industry currently are of the order of 1.8 m in length, so that, where this is attached at the level of the feet of the worker, there is a potential drop of 3.6 m. This exceeds the drop specified in some relevant work safety standards. These lanyards can be shock absorbing and extend for a further metre or more in a fall.

One method proposed to address at least some of the problems of the current scaffolding practice is the 1 metre lift which involves the installation of a full intermediate platform at the 1 m height in each vertical column of bays. This substantially increases the amount of material and the weight of the scaffolding.

### SUMMARY OF THE INVENTION

According to an embodiment of the invention there is provided a scaffolding assembly including at least one scaffolding climbing tower including four corner standards, and one or more climbing platforms, each climbing platform having a climbing space.

The climbing platform can extend less than the full depth of a bay.

The climbing platform can extend beyond half the depth of a bay.

The position of the climbing platforms can be staggered to prevent an uninterrupted vertical drop within the scaffolding.

From one to three intermediate platforms can be provided between the height of working platforms in an adjacent working platform tower.

The climbing platforms can be spaced vertically of the order of half the height of adjacent working platforms.

Climbing platforms include ledgers and transoms, and intermediate ledgers can be installed between climbing platforms.

The invention also provides a method of assembling a scaffolding climbing tower including a plurality of climbing platforms, the method including the steps of:

(A) erecting four standards defining the corners of a climbing tower;
(B) erecting a climbing platform at approximately half working platform height;
(C) installing at least one intermediate ledger above the climbing platform;
(D) attaching a lanyard to the intermediate ledger;
(E) climbing to the climbing platform;
(F) installing risers and ledgers for the next climbing platform;
(G) attaching a lanyard to a riser for the next climbing platform;
(H) installing risers for the next stage;
(I) assembling the next climbing platform opposite the previous climbing platform; and
(J) repeating the process until sufficient climbing platforms have been installed.

The method can include the step of:

(K) installing a second climbing platform after step (E).

The method can include the step of

(L) installing a second climbing platform after step (K).

Two short restraint lanyards can be used so that continuous attachment is provided by at least one lanyard.

The invention also provides a method of assembling scaffolding including the steps of:

erecting a climbing tower by the method of any one of claims 8 to 11; and
(M) extending the scaffolding on at least one side of the climbing tower using the climbing tower to climb to the level being worked and working outward from the climbing tower.

The scaffolding assembly can include at least one scaffolding climbing tower defined by four corner standards, and one or more climbing platforms.

The climbing platforms can alternate from the front and back of the climbing bay.

At least some of the climbing platforms can give access to working platforms.

The working platforms can extend to the width and depth of a bay, while the climbing platforms can extend less than the full depth of a bay.

The climbing platforms can extend at least half the width of the bay.

The climbing platforms can be spaced of the order of 1 m vertically.

The present invention also provides a harness and lanyard arrangement for use with eth scaffolding assembly above, the harness including straps or webbing adapted to be wound around a users legs and torso and shoulders and having a rearward located connection point for connecting a lanyard portion thereto, a first lanyard portion of a first length having an end fitting to slidably capture a scaffolding member therein and a second lanyard portion of a second length having an end fitting to slidably capture a second scaffolding member therein.

The first length can be shorter than the second length.

The first lanyard portion adapted to be used to secure to a scaffolding member adjacent to the user.

The second lanyard portion being adapted to be used to secure to a scaffolding member at a location above the user.

At least one short restraint lanyard can be used in erecting a climbing bay according to an embodiment of the invention.

The lanyard can be of the order of 0.6 m in length.

Intermediate ledgers can be provided on the risers of a climbing bay to provide reduced distances between anchor ledgers to which short harness can be attached.

Preferably short lanyards are used until at least 6.5 m above ground as this can be approximately the effective height of a shock arresting lanyard in some circumstances.

### BRIEF DESCRIPTION OF THE DRAWINGS

An embodiment or embodiments of the present invention will now be described, by way of example only, with reference to the accompanying drawings, in which:

FIG. 1 illustrates the current method of erecting scaffolding;

FIG. 2 shows a schematic view of a single column of a scaffolding assembly with three working platforms;

FIG. 3 is a schematic side view of a scaffolding assembly according to a second embodiment of the invention;

FIG. 4 is a schematic view of a scaffolding assembly climbing bay according to an embodiment of the invention;

FIG. 5 is a flow diagram of a method of assembling scaffolding according to an embodiment of the invention;

FIG. 6 shows a section of a standard pipe with a cup attachment;

FIG. 7 shows a section of a standard pipe with a star attachment and female attachment;

FIG. 8 is a schematic illustration of the method of the invention in use;

FIG. 9A shows a partial view of a scaffolding assembly having a climbing tower according to an embodiment of the invention; and

FIG. 9 shows another partial view of a scaffolding assembly having a climbing tower according to another embodiment of the invention.

### DETAILED DESCRIPTION OF THE EMBODIMENT OR EMBODIMENTS

The invention will be described with reference to the embodiments shown in the drawings.

The convention used in the drawings is that the digits before the decimal point indicate the figure reference number, and the digits after the decimal point indicate the specific element of the drawings. Where possible, the same element reference numbers are used for the same items in different figures.

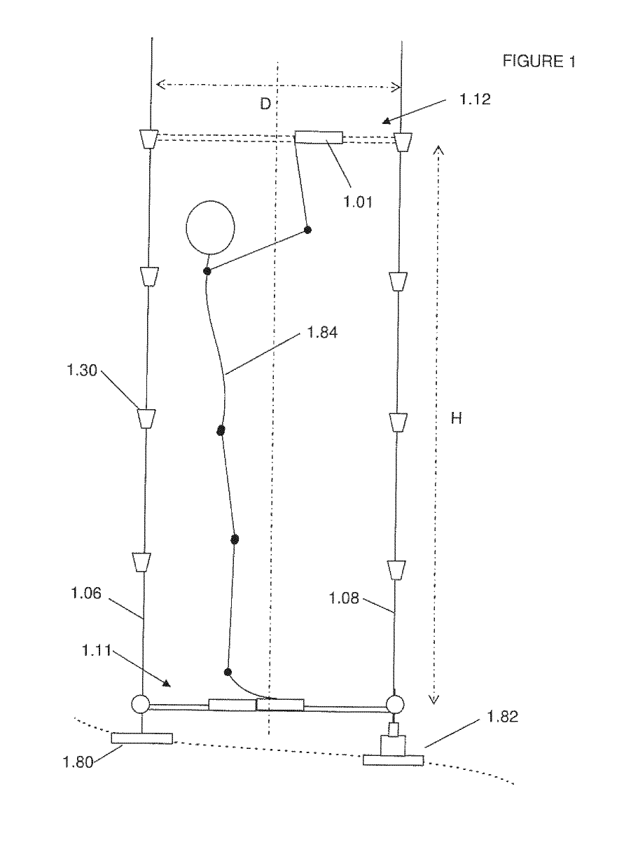

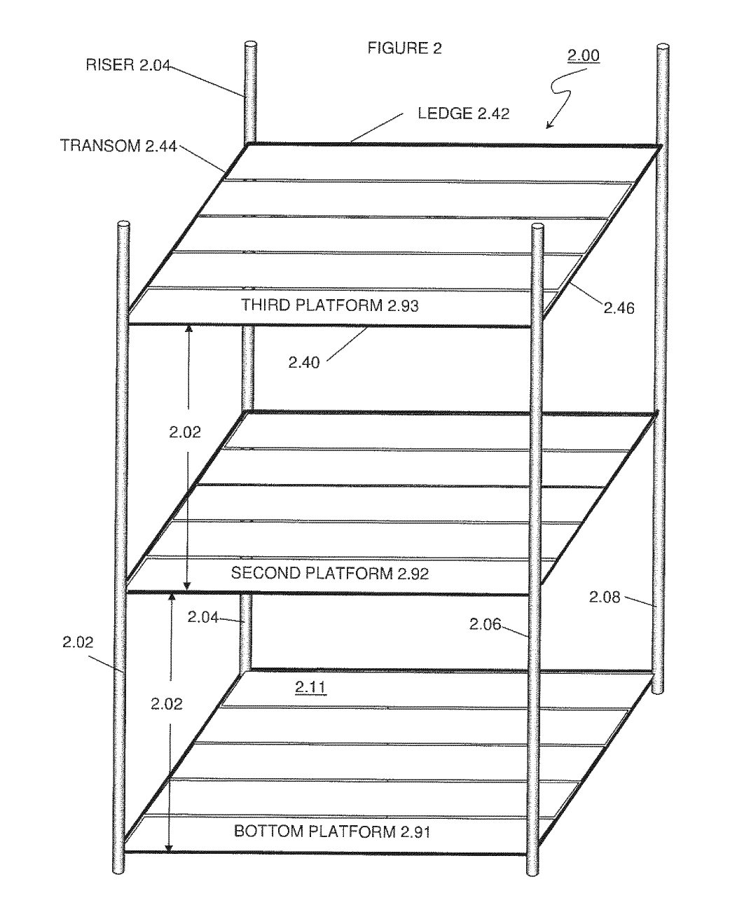

FIG. 1 shows portion of a scaffolding assembly according to current practices. Four standards 1.02, 1.04, 1.06, 1.08 are assembled in a rectangular configuration, according to the prevailing industry practice and industry standards. Typically, the length of the rectangle between standards 1.02 and 1.06 is about 7.2 m, and the depth is about 1.2 m. The vertical spacing between platforms such as 1.10 and 1.12, and 1.12 and 1.14 is of the order of 2 m. Each platform is bounded by a pair of transoms 1.44, 1.46, and a pair of ledgers 1.40, 1.42. The transoms are usually L-beams or inverted T-beams so the platform boards 1.11 can be supported in the angle of the transoms. According to industry practice, the depth of the bay as defined by the distance between standard 1.02 and 1.04 is chosen to permit five boards 1.11 to form the platform. The boards can be of a standard size and load bearing capacity. Such scaffolding assemblies can be required to be several tens of metres wide and can also be more than 8 metres high.

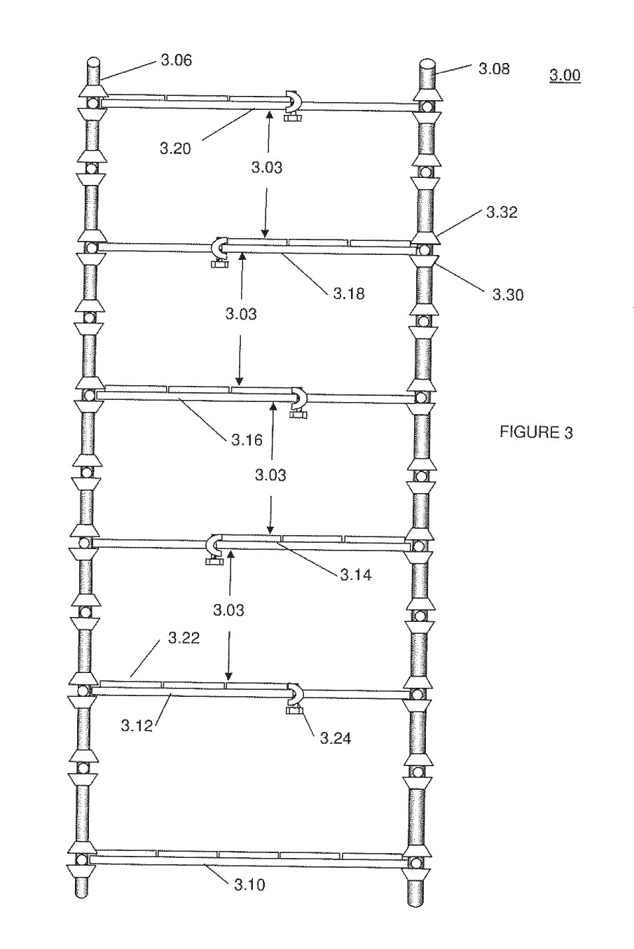

FIG. 3 is a schematic end view of a scaffolding arrangement according to an embodiment of the invention.

A front standard 3.06 and a back standard 3.08 are shown supporting in order from the bottom: a ground platform 3.10, a first climbing platform 3.12, a second climbing platform 3.14, a third climbing platform 3.16, a fourth climbing platform 3.18, a fifth climbing platform 3.20. Each of the climbing platforms 3.12, 3.14, 3.16, 3.18, and 3.20 has three boards. The boards are held in position in the transoms by clamps such as 3.24 which are attached to the corresponding transom, for example by a screw fastening. This prevents the boards sliding in the transom.

The standards 3.06, 3.08 can be fitted with attachment means such as cups 3.30, 3.32 at regular intervals, such as 0.5 m intervals in accordance with the typical spacing of the attachments 3.30.

The standards can have attachment cups at 0.5 metres. The climbing platforms can be located conveniently at the heights of attachment cups, for example every 1 metre, so there can be, for example three climbing platforms within a 3.2 metre standard. Thus, when a worker stands on the second climbing platform, the next standard section can comfortable be installed at waist height instead of above shoulder height.

In erecting the climbing bay of FIG. 3, the four standards are erected and the base platform constructed using the five boards. Then the climbing platform 3.33 is erected at three-quarter bay height. Thus the worker does not have to lift the boards above head height, as the bay is at 2*0.75 m=1.5 m. The boards can be supplied using the front ledger as a pivot for first worker on the ground to pass the boards to the second worker in the bay. Using the inventive system, workers erecting the scaffolding do not need to raise boards above their heads. In addition, once the ledgers for the intermediate platform 3.16 have been positioned, the workers erecting the scaffolding always have a ledger at or above shoulder height to which to attach the lanyard, as the next level of ledgers can be installed before the worker climbs further up the climbing bay. Using two lanyards, continuous attachment can be maintained by connecting the second lanyard to a higher attachment point before releasing the first lanyard.

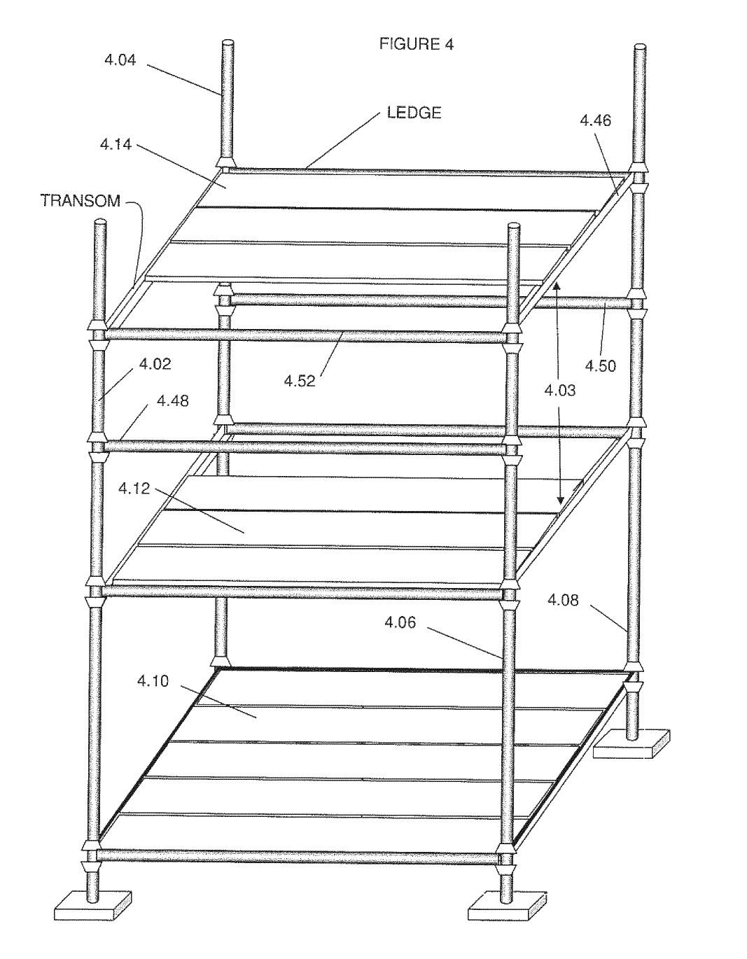

FIG. 4 shows a scaffolding assembly climbing bay according to a first embodiment of the invention. The four standards 4.02, 4.04, 4.06, 4.08 are arranged in the normal rectangular configuration and a ground platform 4.10 is installed. Intermediate ledgers 4.48, 4.40 are then installed between just above half height and ⅞ths bay height to provide anchor points for the short lanyards. In this embodiment, the intermediate ledgers are 0.5 m above the climbing platform. Then a first climbing platform 4.12 is installed. At least three boards of the first climbing platform 4.12 can be assembled intermediate the ground platform and the standard platform height, and below the intermediate ledgers. Clamps such as 3.24 (FIG. 3) are used to hold the partial platforms in place. The first climbing platform is located approximately 1 m above the ground platform 4.10 in a standard 2 m high bay. The worker can then attach a first short lanyard to the ledger 4.50 and climb onto the first climbing platform 4.12, and install the ledger 4.52. When the ledger 4.52 has been installed, the worker can attach a second short lanyard to the ledger 4.52, and release the first lanyard from ledger 4.50. The worker can then install the remaining ledgers and transoms for the second climbing platform 4.14, with the boards being aligned against the opposite side of the bay to those of the first climbing platform. The process is repeated until the required height is obtained.

As the climbing platforms are assembled, the additional ledgers are added at 0.5 m intervals so there is always at least one ledger above waist height to which the worker can attach a lanyard. The lanyard can be a restraint lanyard of 600 mm length.

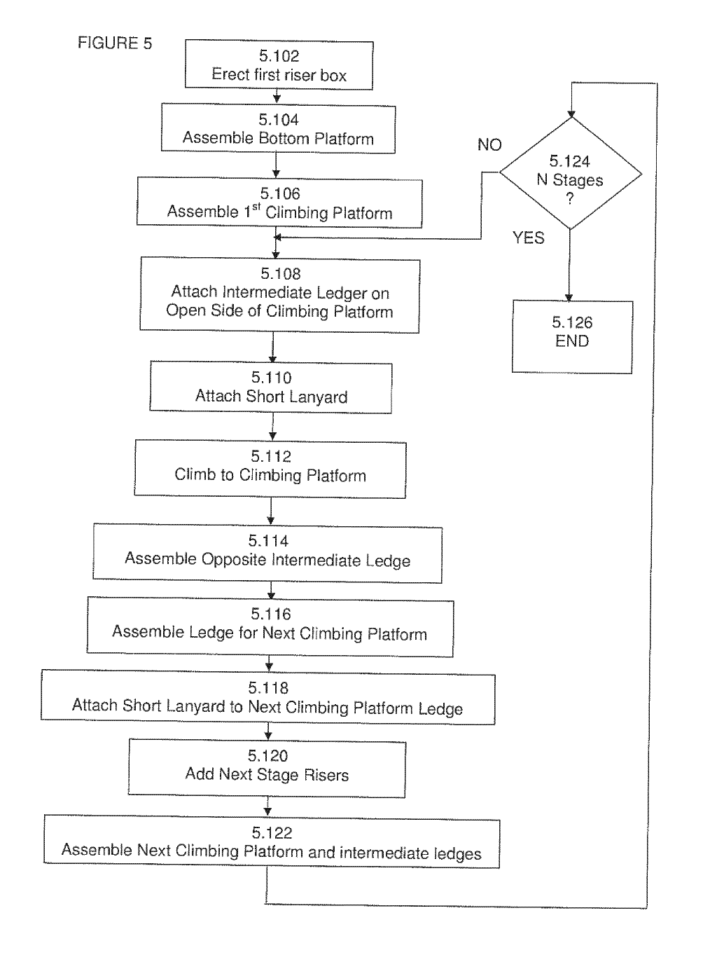

While the exact sequence of assembling the climbing platform and intermediate ledgers can be varied, FIG. 5 illustrates a process for erecting a climbing tower according to an embodiment of the invention.

At step 5.102, the first stage of the riser box is erected and the ground platform is assembled at 5.104. The first climbing platform can then be assembled at step 5.106. At this stage there is no requirement for the use of a lanyard as the worker is still working on the ground platform. At step 5.108, the worker can then assemble the intermediate ledger above the first climbing platform and proximate the open side of the climbing platform. Alternatively, the intermediate ledgers can be installed before the climbing platform is assembled. The worker can then attach a short lanyard to the intermediate ledger, 5.110, and climb onto the climbing platform, 5.112. The opposite intermediate ledger can be installed at 5.114, and the ledgers for the next climbing platform can then be installed at 5.116, so the worker can attach a second short lanyard to the ledger of the next climbing platform at 5.118. The risers adjacent to the climbing platform for the next stage can then be installed 5.120. Then next intermediate ledger and the next climbing platform can be installed at 5.122. The process is repeated until the required number of climbing stages has been installed.

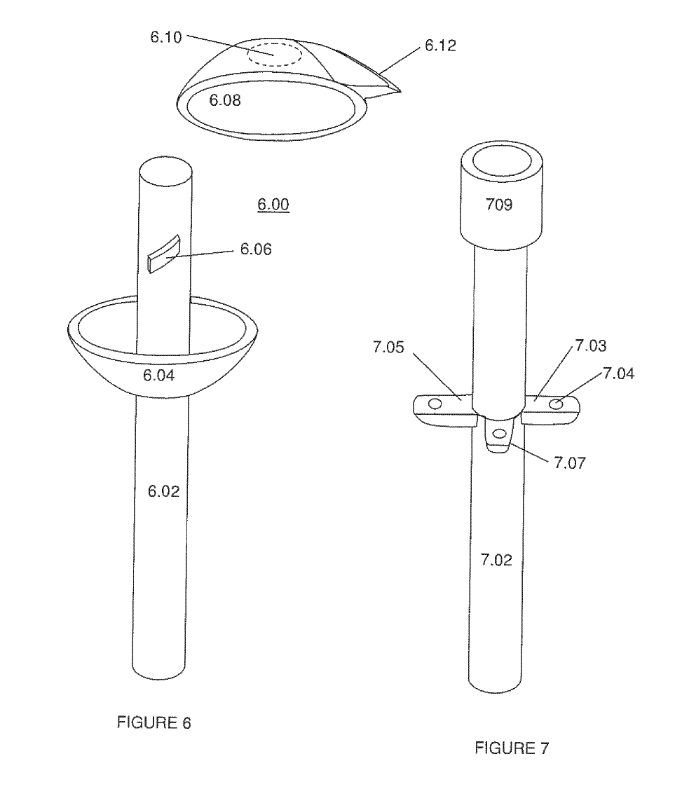

There are various types of attachment means adapted to receive complementarily shaped ends of transoms and ledgers. For example, a cup attachment is shown in FIG. 6 and includes a cup shaped attachment 6.04 permanently attached to the standard 6.02. The cup is adapted to receive hooked ends of transverse members such as transoms and ledgers. Four such transverse members can be attached to a cup. A clamp member, such as sliding cap 6.08 with an aperture 6.10 can be provided to lock the transverse members in place. The aperture 6.10 is a sliding fit on the standard 6.02. An angled projection 606 can be provided on the standard 6.02, and the cap 6.08 can include a complementarily angled groove to engage with the projection 6.06, so that when the cap is rotated, if is forced down to clamp on the engagement ends of the ledgers and transoms located in the cup 6.04. The complementary groove can be formed in the aperture 6.10. A locking projection 6.12 can be provided so that the cap 608 can be secured in place by tapping the projection 6.12 with a hammer.

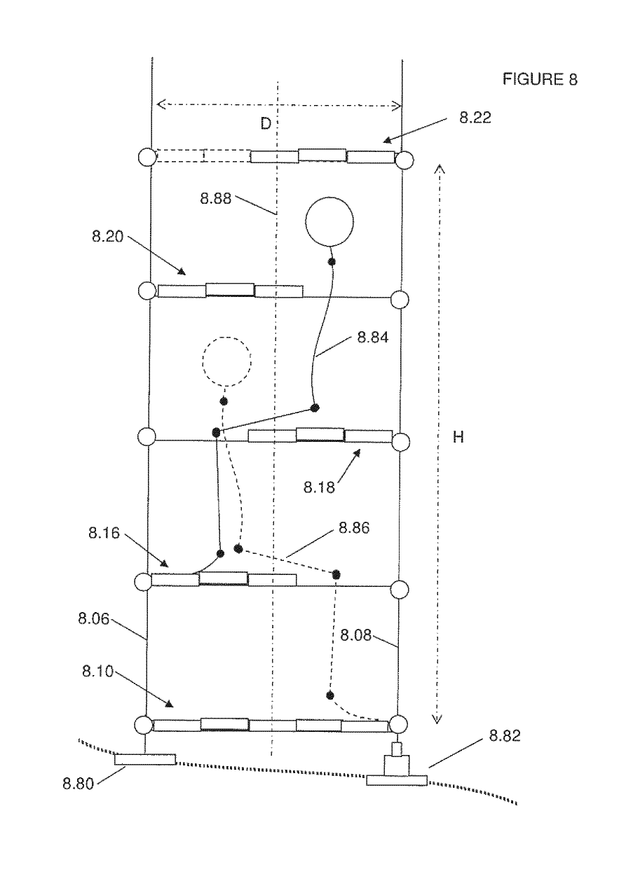

FIG. 7 illustrates a “star” attachment with four orthogonal projections, only three of which are shown at 7.03, 7.05, 7.07. Each projection includes a hole such as 7.04 to receive the engaging end of a transom or ledger. Again, locking means can also be provided to retain the engagement of the transom and the projections. The standard 7.02 is also provided at its upper end with a female coupling element 7.09 adapted to engage with a complementary male end of another standard.

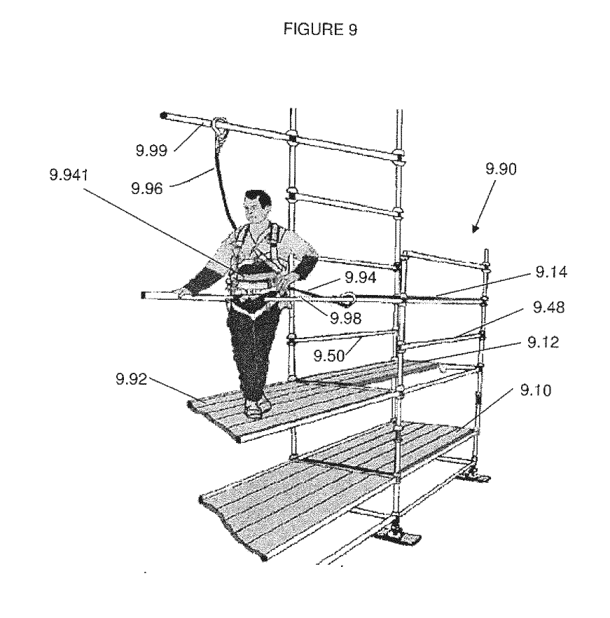

FIG. 8 a schematic illustration of the method of the invention in use in a climbing bay illustrating the inventive concept.

FIG. 8 shows a side view of a climbing bay of scaffolding erected according to an embodiment of the invention. The bay is defined by a pair of standards 8.06, 8.08 visible in side view, a ground platform 8.10, and a number of climbing platforms 8.16, 8.18, 8.20, 8.22. The standards 8.06, 8.08 can be fitted to footings 8.80, 8.82. One or more of the footings can be adjustable to take account of sloping ground.

As shown in FIG. 8, the 1 m spacing of the climbing platforms permits the worker to climb between platforms by sitting on the platform and raising his legs to the platform as shown by the stick figures 8.84, 8.86. Thus a worker can climb up the climbing tower by sitting on a platform and raising his or her legs to that platform, standing and turning 180°, and sitting on the next platform, and again raising his or her legs to the platform on which he or she is sitting. Climbing down can be achieved in a similar manner. As the centre line 8.88 shows, there is no direct fall line within the climbing bay because the three boards on one level overlap those of the platforms above and below.

Scaffolding several bays high can be erected in this fashion, leaving the working platforms to be installed in adjacent bays. In traditional scaffold construction, each vertical line of bays is constructed upwards from the ground. In a further refinement of the invention, the climbing tower is erected, and the bays to either side can then be built by workers climbing up to the require height in the climbing bay and then building out sideways from the climbing tower.

One reason for using the climbing platforms provide convenient working heights which minimize the amount of lifting required in erecting the scaffolding. Additionally, traditional scaffolding standards have the bay heights divided into quarters by three intermediate attachment cups or stars so the intermediate ledgers can be installed at these standard spacings. However, the invention is applicable to other standard arrangements, such as where there are only two intermediate levels of attachment cups or stars.

The bay has a height H, typically 2 m, and a depth D of the order of 1.2 m. The climbing platforms 8.16, 8.18, 8.20, 8.22, each consisting of 3 boards are shown in a staggered alignment, platforms 8.16 and 8.20 abutting standard 8.06, while platforms 8.18 and 8.22 abut standard 8.08. The base platform 8.11 can be fully assembled using five boards.

Using the system of the present method, a worker can easily install ledgers which are above shoulder height in a sequence which ensures that there is always a ledger above shoulder height to which one lanyard can be attached before detaching the other lanyard from a lower ledger. In addition, the more frequent provision of anchoring ledgers according to the invention permits the use of shorter lanyards, such as a 600 mm lanyard, rather than the 1.8 m lanyard typically used in scaffold erection. Thus the potential fall distance is substantially reduced.

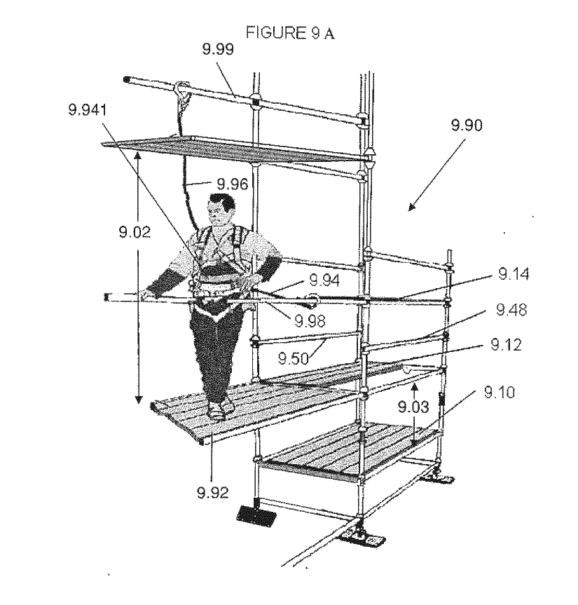

FIGS. 9 and 9A schematically illustrates a partial view of a scaffolding assembly having a climbing tower 9.90 according to embodiments of the invention.

The climbing tower includes a base platform 9.10 having five boards and extending the full depth of the bay. A first climbing platform 9.12 having three boards is also shown, and a second climbing platform is installed at 9.14. Intermediate ledgers 9.48, 9.50 are also installed between climbing platforms 9.12 and 9.14.

In an adjacent working platform bay, a working platform 9.92 is shown at the same level as climbing platform 9.12. The worker has a harness 9.941 which has straps or webbing which surrounds the worker's legs, and the workers torso and passes over the workers shoulders, to a rear location of which is a connections point for a first short lanyard 9.94 which releasably and slidingly attaches to ledger 9.98 and a second longer lanyard 9.96 which releasably and slidingly attaches to ledger 9.99. The working platforms can be spaced 2 m apart vertically. After the climbing platform has been assembled, a long lanyard can be used by a worker on a working platform above the 6 metre height. However, while ascending or descending the climbing tower, two short lanyards should be used to maximize the safety benefits of the system.

Preferably, the climbing platforms on the same level as the adjacent working platforms are located on the inside, ie, adjacent to the work structure.

In disassembling the scaffolding, the working platforms on either side are removed starting from the top outermost platforms and working inwards towards the climbing tower. Preferably, one level is removed at a time, starting with the top level.

This method of construction uses less material than the 1 m lift method in that the 1 m lift method adds a full platform in each vertical column of bays, while, with the present invention, the climbing tower has two climbing platforms per bay. Thus, for large scaffolding works, there can be substantial saving of the use of intermediate boards using the present invention. The invention has other advantages in safety as will be apparent to the skilled worker in the field.

The following table sets out instructions for assembling a climbing tower.

| | | | |
|---|---|---|---|
| 1.6 | Insert three x scaffold planks at 4th cup level in | Ground | No attachment |
| | climbing bay 2 m above ground level and secure | level | required |
| | using 2 girder clamps attached to transom with | | |
| | girder clamps hard against board one each end. | | |
| 2. | Working at Heights 2 m and above | 2^{nd} cup | 0.6 m lanyard |
| | | level | attached to |
| | | | climbing bay |
| | | | ledger |
| 2.1 | Ascend climbing bay from the fully decked out | ascending | 0.6 m lanyard |
| | bay climb to the next level (1 metre) using the | | attached to |
| | ledgers to pull yourself up. | | climbing bay |
| | Before standing on the boards you must attach | | ledger/A |
| | your lanyard from your hip to the ledger 1 metre | | |
| | above deck level prior to accessing that level. | | |
| 2.2 | Top up Climbing Bay 4 x Standards in climbing | 4^{th} cup | 0.6 m lanyard |
| | bay Install ledgers in every cup of climbing bay | level | attached to |
| | that you can reach install transoms at 2 m | | climbing bay |
| | above the deck you are standing on | | ledger |
| 3.0 | Working From Climbing Bay to all outer areas | 4^{th} cup | 0.6 m lanyard |
| | | level | attached to |
| | | | climbing bay |
| | | | ledger |
| 3.1 | still attached to the ledger inside climbing bay, | 4^{th} cup | 0.6 m lanyard |
| | walk onto the boards on your out bay to install | level | attached to |
| | the ledger 1 metre above the deck you are | | climbing bay |
| | standing on (2 cups) | | ledger |
| 3.2 | once ledger is installed attach 2^{nd} restraint | 4^{th} cup | 0.6 m lanyard |
| | lanyard from your side D ring to installed ledger | level | attached ledger |
| | Unhook your restraint lanyard from your | | |
| | climbing bay | | |
| | Install ledger parallel to last installed ledger | | |
| 3.3 | Top up that bay with your standards and | 4^{th} cup | 0.6 m lanyard |
| | complete lift at 2 m | level | attached ledger |
| 3.4 | The same process (3.1 & 3.2) shall apply to all | 4^{th}-6^{th} | .6 m lanyard |
| | outer bays | cup level | attached ledger |
| 3.5 | When completed return to climbing bay | | .6 m lanyard |
| | Install 4 transoms at 1^{st} & 2^{nd} cup above the | | attached ledger |
| | deck you are standing on | | |
| | Install Boards on the opposite to the deck you | | |
| | are standing on | | |
| | Fix girder clamps to transom hard against the | | |
| | board | | |
| | These steps should be repeated for all. Outer | 6^{th} cup | 0.6 m lanyard |
| | bay lifts, until the scaffold has reached its | level | attached to |
| | required height. | | climbing bay |
| | | | ledger |
| 18 | Ascend climbing bay attach 0.6 ml lanyard to | 6^{th} cup | 0.6 m lanyard |
| | ledger at hip level then stand on 3 secured | level | attached to |
| | planks at 6^{th} cup level | | climbing bay |
| | | | ledger |

According to some standards, each working bay can include as few as two boards, so working bays do not need to include 5 boards. Thus, as the climbing platforms at the 2 m stage are erected, it is also possible to commence erecting the adjacent working platforms at the 2 m height using 2 boards per working platform. The additional risers for the working bays can thus be added from the 2 m working platforms.

In this specification, reference to a document, disclosure, or other publication or use is not an admission that the document, disclosure, publication or use forms part of the common general knowledge of the skilled worker in the field of this invention at the priority date of this specification, unless otherwise stated.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A scaffolding assembly including at least one scaffolding climbing tower including four corner standards, and one or more climbing platforms, each climbing platform having a climbing space.

2. A scaffolding assembly as claimed in claim 1, wherein the climbing platform extends less than the full depth of a bay.

3. A scaffolding assembly as claimed in claim 1, wherein the intermediate platform extends beyond half the depth of a bay.

4. A scaffolding assembly as claimed in claim 1, wherein the position of the climbing platforms is staggered to prevent an uninterrupted vertical drop within the scaffolding.

5. A scaffolding assembly as claimed in claim 1, including from one to three intermediate platforms between working platforms in an adjacent working platform tower.

6. A scaffolding assembly as claimed in claim 1, wherein the climbing platforms are spaced vertically of the order of half the height of adjacent working platforms.

7. A scaffolding assembly as claimed in claim 1, wherein climbing platforms include ledgers and transoms, and wherein the intermediate ledgers are installed between climbing platforms.

8. A method of assembling a scaffolding climbing tower including a plurality of climbing platforms, the method including the steps of:
(A) erecting four standards defining the corners of a climbing tower;
(B) erecting a climbing platform at approximately half working platform height;
(C) installing at least one intermediate ledger above the climbing platform;
(D) attaching a lanyard to the intermediate ledger;
(E) climbing to the climbing platform;
(F) installing risers and ledgers for the next climbing platform;
(G) attaching a lanyard to a riser for the next climbing platform;
(H) installing risers for the next stage;
(I) assembling the next climbing platform opposite the previous climbing platform; and
(J) repeating the process until sufficient climbing platforms have been installed.

9. The method of claim 8, including the step of (K) installing a second climbing platform after step (E).

10. The method of claim 9, including the step of (L) installing a second climbing platform after step (K).

11. A method as claimed in claim 8, wherein two short restraint lanyards are used so that continuous attachment is provided by at least one lanyard.

12. A method of assembling scaffolding including the steps of:
erecting a climbing tower by the method of claim 8; and
(M) extending the scaffolding on at least one side of the climbing tower using the climbing tower to climb to the level being worked and working outward from the climbing tower.

13. A harness and lanyard arrangement for use with a scaffolding assembly, the harness including straps or webbing adapted to be wound around a users legs and torso and shoulders and having a rearward located connection point for connecting a lanyard portion thereto, a first lanyard portion of a first length having an end fitting to slidably capture a scaffolding member therein and a second lanyard portion of a second length having an end fitting to slidably capture a second scaffolding member therein.

14. A harness and lanyard arrangement as claimed in claim 13, wherein the first length is shorter than the second length.

15. A harness and lanyard arrangement as claimed in claim 13 wherein the first lanyard portion is adapted to be used to be secured to a scaffolding member adjacent to the user.

16. A harness and lanyard arrangement, as claimed in claim 13, wherein the second lanyard portion is adapted to be used to secure to a scaffolding member at a location above the user.
